(19) United States
(12) Patent Application Publication
(10) Pub. No.: US 2006/0199888 A1
(43) Pub. Date: Sep. 7, 2006

(54) Red-colored metallic paint formulations

(76) Inventors: Takayuki Ono, Nishikamo-gun (JP); Masahiro Endo, Nishikamo-gun (JP); Yasushi Nakao, Obu-shi (JP)

Correspondence Address: WENDEROTH, LIND & PONACK, L.L.P., 2033 K STREET N. W., SUITE 800, WASHINGTON, DC, 20006-1021, US

(21) Appl. No.: 11/364,337

(22) Filed: Mar. 1, 2006

(30) Foreign Application Priority Data
Mar. 2, 2005 (JP) 2005-56763

(51) Int. Cl. C08K 3/22

(52) U.S. Cl. 524/431; 524/441

(57) ABSTRACT

This invention relates to a red-colored metallic paint formulation which comprises a resin component, aluminum flake pigment and red iron oxide pigment, characterized in that it contains, per 100 parts by weight of total solid content of the resin component, 1-30 parts by weight of the aluminum flake pigment and 0.1-10 parts by weight of the red iron oxide pigment, and that the red iron oxide pigment has an average primary particle size of at least 200 nm.

### TECHNICAL FIELD

This invention relates to paint formulations forming red-colored coating film which has high value under highlight, high chroma in the shade and exhibits excellent weatherability; coating film-forming methods using the paint formulations; and articles coated with the paint formulations.

### BACKGROUND ART

Generally for preparation of high chroma red-colored metallic coating film, paint formulations comprising aluminum flake pigment and red coloring pigment have been used. In particular, for forming high chroma metallic coating film, transparent red iron oxide pigment or organic red pigment of small particle size are used as the coloring pigment.

However, when pigment of small average particle size is used as the coloring pigment to be concurrently used with aluminum flake pigment, resulting coating film has high value and high chroma under highlight but has a low chroma in the shade. This gives rise to a problem that the value and chroma decrease in transition from highlight to shade, resulting in dull painted color. In particular, furthermore, because many of organic red pigments having low primary average particle size show inferior weatherability, when the coating film is exposed to outdoor air for long, the color tends to change or fade.

As a method for forming high chroma red metallic coating film, for example, JP2001-321719A discloses one for forming laminated mica coating film which comprises forming a color base coating film on a substrate on which undercoat and intermediate coat have been formed, hardening the color base coating film, successively forming thereon a mica base coating film and a clear coating film by the order stated and simultaneously hardening the two coating films, in which the mica base coating film contains colored aluminum pigment and mica pigment, and the hue of the color base coating film and that of the colored aluminum pigment are of similar colors. However, this method is subject to a problem that a color base coat of a similar color to that of the mica base coat must be used due to the latter's low hiding power, which incurs limitation on coating steps. Furthermore, the colored aluminum pigment which is contained in the color base coating film is an aluminum flake pigment coated (wet system) with coloring pigment used for paint, and depending on the coloring pigment used for the coating, its weatherability may be unsatisfactory. In particular, because majority of red color pigments exhibit inferior weatherability, prolonged outdoor use of thereby coated articles is apt to cause discoloration or color fading of the coating film. Besides, the film's chroma in the shade cannot be regarded sufficient.

### DISCLOSURE OF THE INVENTION

The main object of the present invention is to provide paint formulations which enable formation of red-colored coating film which has high value under highlight and high chroma in the shade and exhibits excellent weatherability.

Having engaged in concentrative research work, the present inventors now found that the above object could be accomplished by blending each a specific amount of aluminum flake pigment and red iron oxide pigment with red-colored metallic paint, and by using as the red iron oxide pigment the one having a large primary average particle size; and have completed the present invention.

Accordingly, therefore, the invention provides a red-colored metallic paint formulation which comprises a resin component, aluminum flake pigment and red iron oxide pigment, characterized in that it contains 1-30 parts by weight of the aluminum flake pigment and 0.1-10 parts by weight of the red iron oxide pigment, per 100 parts by weight of the total solid content of the resin component; and that the red iron oxide pigment has average primary particle size of at least 200 nm.

The invention also provides a method for forming multi-layered coating film, which comprises applying the above red-colored metallic paint formulation onto a substrate, and then applying clear paint onto so formed coating film.

When the above paint formulation of the present invention is used, such remarkable effect is achieved that red-colored coating film which has high value under highlight and high chroma in the shade, and which scarcely develops discoloration or color fading even when left outdoors over prolonged period can be readily formed.

Hereinafter the paint formulations according to the present invention and the coating film-forming methods using the same are explained in further details.

Those paint formulations according to the present invention are red-colored metallic paint formulations comprising a resin component, aluminum flake pigment and red iron oxide pigment.

Resin Component:

As the resin component in the paint formulations of the present invention, those which are generally used as vehicles in the art of paint can be similarly used. The component normally comprises main resin and crosslinking agent. As specific examples of main resin, acrylic resin, polyester resin, alkyd resin, urethane resin and the like, which have crosslinking functional groups such as hydroxyl, carboxyl, epoxy and the like, can be named. Also as the crosslinking agent for hardening the main resin, for example, melamine resin, urea resin, polyisocyanate compound, blocked polyisocyanate compound and the like can be named. They are normally used in the forms as dissolved or dispersed in organic solvent, water or mixtures thereof. The relative ratio between the main resin and the crosslinking agent in the resin component is not strictly limited, while it can normally be, in terms of main resin/crosslinking agent weight ratio, within a range of 30/70-90/10, preferably 50/50-80/20.

Aluminum Flake Pigment:

The paint formulations according to the present invention contain aluminum flake pigment, with the view to impart metallic effect to the coating film formed. As the aluminum flake pigments useful for the present invention, those used as metallic pigments in the art of dye and are known per se can be similarly used.

Aluminum flake pigment is in the form of scaly particles which are obtained by, for example, using as the starting material particulate atomized powder formed upon spraying molten aluminum metal or aluminum foil pieces, crushing and grinding such starting materials with mechanical impact strength exerted in stamp mill method or wet or dry ball mill method, or grinding them in a rotating ball mill concurrently with milling lubricant in the presence of organic solvent such as mineral spirit. Depending on the kind of the milling lubricant, the pigment can be largely classified into leafing type and non-leafing type. Normally those of the particle size ranging 5-100 μm in terms of average particle diameter and about 0.05-5 μm in thickness are used. While either of leafing type and non-leafing type can be used in the present invention, non-leafing type aluminum flake pigment formed with oleic acid used as the milling lubricant is particularly preferred.

The content of such aluminum flake pigment in the paint formulations of the present invention can be within a range of 1-30 wt parts, preferably 3-25 wt parts, inter alia, 5-22 wt parts, as solid, per 100 wt parts of total solid in the resin component, from the viewpoint of finished appearance of coating film.

Red Iron Oxide Pigment:

The paint formulations of the present invention contain red iron oxide pigment having average primary particle size not less than 200 nm, preferably 210-800 nm, inter alia, 400-600 nm, for the purpose of determining hue of formed coating film, in particular, hue in the shade and also of enhancing chroma of the coating film in the shade. Red iron oxide pigment is a collective name of those orange red to chestnut colored pigments whose chief component is ferric oxide (Fe₂O₃), represented by Indian red. They may be surface treated with silica or zirconia. The red iron oxide pigment content of a paint formulation according to the present invention can be within a range of 0.1-10 wt parts, preferably 0.5-8 wt parts, inter alia, 1-5 wt parts, per 100 wt parts of the total solid of the resin component, from the viewpoint of chroma of resulting coating film.

Paint formulations of the present invention may further contain, within a range not causing turbidity in color in the shade, red-colored pigment of primary average particle diameter not greater than 100 nm. As such red colored pigments that can be blended, those generally referred to as transparent pigment are preferred, specific examples of which including transparent iron oxide pigment, diketopyrrolopyrrole pigment, quinacridone pigment and perylene pigment. Normally, blend ratio of these red-colored pigments is preferably not more than 10 wt parts, in particular, in the range of 0.01-8 wt parts, inter alia, 0.1-5 wt parts, per 100 wt parts of total solid in the resin component.

“Average primary particle diameter” of each pigment in the present specification is determined as follows. For effect pigment represented by aluminum flake pigment, each sample pigment is added to clear lacquer paint at a ratio of 15 wt parts per 100 wt parts of the solid resin component of the paint, uniformly dispersed by stirring and mixing, applied onto art paper advancedly coated with N-6 Gray intermediate paint, to a thickness of 20 μm in terms of its dry film thickness, dried, and the resulting coating film is observed with a video microscope at 1250× magnification while changing the visual fields. The average value of longer diameters of 100 unit pigment particles in the visual fields as visually measured is indicated as the average primary particle diameter. In case of coloring pigment, the value is measured with disc centrifugal precipitation type line start method particle size distribution measuring apparatus (BI-DCP™, Nikkiso Kabushiki Kaisha).

Paint Formulations;

Paint formulations of the present invention comprise the resin component, aluminum flake pigment and red iron oxide pigment as above-described, and where necessary, may further suitably contain customary paint additives, for example, solvent such as water, organic solvent or mixtures thereof; pigment dispersant, antisettling agent, hardening catalyst, defoaming agent, antioxidant, UV absorber, surface regulating agent or the like; extender, and the like.

The paint formulations of the present invention can take such forms as organic solvent-based, water-based and non-water dispersible type, any of which can be prepared by mixing and dispersing individual components as so far described, following per se known paint formulation method. A paint formulation according to the present invention preferably has a solid content within a range of normally 12-50 wt %, in particular, 15-30 wt %, at the time of application, and its viscosity at 20° C. preferably is 15-20 seconds/Ford Cup #3.

Coating Film-Forming Method;

Those paint formulations of the present invention can be applied onto a substrate by optional painting means, such as electrostatic coating, air spraying, non-air spraying or the like. Thickness of the coating film preferably is within a range of 5-30 μm in terms of hardened film, from the standpoint of smoothness of coating film. Coating film per se of a paint formulation of the present invention can be crosslinked and hardened by heating at temperatures normally ranging from about 70 to about 150° C.

According to the invention, multi-layered coating film can be formed by applying clear paint on unhardened or hardened coating film of a paint formulation of the present invention which has been applied onto a substrate in the above-described manner.

As substrates which can be coated with paint formulations of the present invention, for example, metals such as iron, zinc, aluminum and magnesium or alloys containing these metals; shaped articles plated or evaporation-deposited with such metals or alloys; and shaped articles of glass, plastics, foams or the like can be named. Those substrates may be given suitable pre-treatment(s) such as degreasing or surface treatment, according to the kind of materials constituting them. It is preferred that undercoat and/or intermediate coat be formed on those substrates in advance.

Undercoat is given for the purpose of concealing substrate surface or imparting corrosion resistance, rustproofness or the like to the substrate, which can be formed by applying an undercoating paint, drying and hardening the same. Useful undercoating paint is subject to no particular limitation and, for example, electrodeposition paint, solvent-based primer and the like can be used.

Intermediate coat is formed aiming at concealing substrate surface or undercoat, improvement in adherability of coating film, or imparting chipping resistance, which can be formed by applying intermediate paint onto the substrate surface or undercoat and drying and hardening the same. Useful intermediate paint is subject to no particular limitation but those known per se can be used, for example, organic solvent-based or water-based intermediate paint comprising thermosetting resin formulation and coloring pigment can be favorably used.

Particularly when a substrate on which undercoat and/or intermediate coat has been formed in advance is used as a starting substrate, the undercoat and/or intermediate coat can be heated and hardened by crosslinkage before application of a paint formulation of the present invention, or it is also permissible to apply a paint formulation of the present invention while the undercoat and/or intermediate coat is still in unhardened condition.

As the clear paint to be applied onto unhardened or hardened coating film of a paint formulation of the present invention, liquid or powdery paint formulation known per se, which comprises a resin component (main resin and crosslinking agent) and solvent, and still other paint additive(s) which are suitably blended where necessary, can be used. The clear paint forms waterwhite or colored, transparent coating film.

As the main resin, for example, acrylic resin, polyester resin, alkyd resin, fluorine-containing resin, urethane resin, silicon-containing resin and the like which contain crosslinkable functional groups such as hydroxyl, carboxyl, silanol, epoxy and the like can be named. As the crosslinking agent, those compounds or resins reactable with the functional groups in the main resins, such as melamine resin, urea resin, polyisocyanate compound, blocked polyisocyanate compound, epoxy compound or resin, carboxyl-containing compound or resin, acid anhydride and alkoxysilane-containing compound or resin can be named.

Such clear paint can further suitably contain, where necessary, solvent such as water, organic solvent or mixtures thereof; and paint additive(s) such as hardening catalyst, defoamer, UV absorber, rheology-controlling agent, antioxidant, surface-regulating agent and the like.

Coloring pigment can further be suitably blended in the clear paint, within a range not impairing the latter's transparency. As such coloring paint, Per se known pigments for ink or paint can be blended, either singly or in combination of two or more. The amount to be blended can be not more than 30 wt parts, preferably within a range of 0.01-15 wt parts, inter alia, 0.1-10 wt parts, per 100 wt parts of total solid in the resin component of the clear paint.

The clear paint can be applied by any means known per se, for example, electrostatic coating, air spraying, airless spraying and the like, preferably to a thickness within a range of 15-70 μm, in terms of hardened coating film. Coating film of the clear paint itself can be normally crosslinked and hardened by heating at temperatures ranging from about 70 to 150° C.

According to the present invention, multi-layered coating film can be formed by a system referred to as 2C2B system, which comprises the steps of applying a paint formulation of the present invention, then heating the coating film to dry and harden the same, thereafter applying above-described clear paint onto the hardened coating film and heating to dry and harden the cleat coating film. It is also permissible to form a multi-layered coating film by “2C1B” system, which comprises the steps of applying a paint formulation of the present invention, setting it where necessary, applying above-described clear paint onto the unhardened coating film, and heating to harden the two coating films simultaneously.

Coating film formed with use of the paint formulations of the present invention has distinct characteristics that it has a value L* not less than 90, in particular, within a range of 100-130, under highlight and a chroma C* not less than 10, in particular, within a range of 10-20, in the shade. Here the value under highlight (part) signifies the value of the coating film seen from the direction of near specular angle, and the chroma in the shade (part) signifies the chroma of the coating film seen from the direction of diffused light free from influence of specular reflection light. More specifically these value L* and chroma C* can be measured on coating film formed by any of the above-described methods on a plate which was advancedly coated with gray-colored (N-7 according to Munsell color system) coating film, with multi-angle spectrophotometer (MA-68II™, X-Rite Co.). In this specification, measuring light ray is radiated onto each sample coating film at an angle of 45°, and the value under highlight is measured at a receiving angle of 15° from the specular angle, and the chroma in the shade is measured at a receiving angle of 110° from the specular angle toward the direction of the measuring light.

### EXAMPLE

Hereinafter the invention is more specifically explained, referring to working examples.

### Examples 1, 2 and Comparative Examples 1-3

(1) Preparation of Substrate

Steel plate (JISG 3141, 400×300×0.8 mm in size) which had been degreased and zinc phosphate-treated was electrodeposition coated with a cationic electrodeposition paint, ELECRON™ 9400HB (Kansai Paint, epoxy resin/polyamine-derived cationic resin, incorporated with blocked polyisocyanate compound as hardening agent), to a thickness of 20 μm in terms of its hardened coating film, followed by heating at 170° C. for 20 minutes to crosslink and harden the film. Thus an electrodeposited coat was formed on the steel plate.

On the resulting electrodeposited coat, an intermediate paint, LUGA-BAKE™ Inter-Coat Gray (Kansai Paint, polyester resin/melamine resin-type, organic solvent-based paint) was coated by air-spraying, to a thickness of 30 μm in terms of its hardened film, followed by heating at 140° C. for 30 minutes to crosslink and harden the intermediate coat. Thus coated plate was used as the substrate.

(2) Formulation of Paint

With a resin component composed of 70 wt parts (solid content) of a hydroxyl-containing acrylic resin (hydroxyl value, 100; number-average molecular weight, 20,000)^{(note 1)}, and 30 wt parts (solid content) of melamine resin^{(note 2)}, aluminum flake pigment A or B^{(note 3)} and coloring red-colored pigment a, b, c, or d^{(note 4)} of each in the wt parts (solid content) as indicated in the following Table 1 were blended per 100 wt parts of the resin component (solid content), mixed and stirred, and diluted with a mixed solvent of ethyl acetate/SWAZOL™ 1000 (Cosmo Oil Co. Ltd., high boiling point petroleum solvent) (weight ratio, 50/50) to a viscosity suitable for coating operation (20 seconds/Ford Cup #3, 20° C.) to formulate organic solvent-based paint formulations each having a solid content of about 25%.

note 1) hydroxyl-containing acrylic resin: Into a reactor equipped with a stirrer, condenser, thermostat, nitrogen-inlet and dropping funnel, 80 wt parts of mixed solvent of xylene/SWAZOL™ 1000 (COSMO Oil Co., Ltd., high boiling point petroleum solvent) (weight ratio, 50/50) and 20 wt parts of n-butyl alcohol were thrown, and the inner atmosphere of the reactor was nitrogen-substituted. Heating and stirring the content of the reactor the inside temperature was maintained at 120° C., into which a monomeric mixture of the following composition was added dropwise over 3 hours:

| | wt parts |
|---|---|
| styrene | 20 |
| butyl methacrylate | 38.6 |
| 2-ethylhexyl methacrylate | 15 |
| hydroxyethyl methacrylate | 12 |
| hydroxyethyl acrylate | 10.7 |
| methacrylic acid | 3.7 |
| 2,2′-azobisisobutyronitrile | 1 |

note 2) Melamine resin: U-ban™ 28-60, Mitsui Cytec Inc., solid content=60 wt %
note 3) Aluminum flake pigment A: ALUMI PASTE GX™ 180A, Asahi Kasei Corporation, aluminum flake pigment paste, solid content=74 wt %
   Aluminum flake pigment B: PaliocromOrange™ L2800, BASF AG, iron oxide-coated aluminum flake pigment paste, solid content=65wt %
Note 4) Red-colored pigment a: TODA COLOR™ 180ED, Toda Kogyo Corp., α-Fe₂O₃, average primary particle diameter=550 nm
   Red-colored pigment b: TODA COLOR™ 140 ED, Toda Kogyo Corp., α-Fe₂O₃, average primary particle diameter=210 nm
   Red-colored pigment c: TODA COLOR™ 100ED, Toda Kogyo Corp., α-Fe₂O₃, average primary particle diameter=100 nm

Red-colored pigment d: Irgazin DPP RED BO™, Ciba Specialty Chemicals. K. K., diketopyrrolopyrrole pigment, average primary particle diameter=460 nm

TABLE 1

| | | Aluminum Flake | | Red-colored | |
|---|---|---|---|---|---|
| | | Pigment | | Pigment | |
| No. | | kind | wt. part | kind | wt. part |
| Example | 1 | A | 20 | a | 4 |
| | 2 | A | 20 | b | 2 |
| Comparable | 1 | A | 20 | c | 1 |
| Example | 2 | A | 20 | d | 2 |
| | 3 | B | 20 | — | — |

(3) Preparation of Test Panels

Each of the paint formulations as formulated in (2) above was applied to the substrate as prepared in (1) above by air spraying, to a thickness of 20 μm in terms of its hardened film and allowed to stand for 15 minutes. Onto the unhardened coated surfaces, a clear paint, LUGA-BAKE CLEAR™ (Kansai Paint, acrylic resin/amino resin type, organic solvent-based) was applied with minibell rotary electrostatic coater under the booth temperature/humidity condition of 25° C./75%, to a thickness of 25-35 μm in terms of its hardened film. After the application, those coated panels were allowed to stand for 15 minutes at room temperature, and then those multi-layered coating films were simultaneously dried and hardened with a hot air current-circulation type drying oven at 140° C. for 30 minutes, to provide test panels.

(4) Performance Tests

Color appearance, value L* and chroma C*, and accelerated weathering of each test panel were evaluated by the following methods. The results were as given in Table 2.

(*1) Color Appearance

The test panels were visually observed and evaluated according to the following standard:
◯: high value under highlight and chroma increase over the transition from highlight to shade
Δ: high value under highlight but no chroma increase over the transition from highlight to shade
X: low value under highlight and no chroma increase over the transition to shade.
   (*2) Colorimetric Test

Value L* and chroma C* of each of the test panels were measured with multi-angle spectrophotometer, MA-₆₈II™ (X-Rite Co.), at 45° illumination; 15°, 110° aspecular viewing.

(*3) Accelerated Weatherability

Each of the paint formulations as prepared in (2) above was applied onto the substrate as prepared in (1) above, with REA gun at the booth temperature/humidity condition of 25° C./75%, to a thickness of 20 μm in terms of its hardened film, follower by 15 minutes' standing at room temperature. Onto the unhardened coated surfaces, a clear paint, LUGA-BAKE CLEAR™ (Kansai Paint, acrylic resin/amino resin type, organic solvent-based paint) was applied with minibell rotary electrostatic coater under the booth temperature/humidity condition of 25° C./75%, to a thickness of 25-35 μm in terms of its hardened film. After the application, these coated plates were allowed to stand for 15 minutes at room temperature, and then those multi-layered coating films were simultaneously dried and hardened with a hot air current-circulation type drying oven at 140° C. for 30 minutes, to provide test panels. Two panels per Example or Comparative Example were prepared, one of which was subjected to the following accelerated weathering test and the other, kept as reserve of the coated panel in the laboratory.

Super Xenon Weather-O-meter™ (Suga Tester Kabushiki Kaisha) as specified in JIS B7754 was used for the accelerated weathering test. Five hundred (500)-cycle repeating test per test panel was conducted, one cycle consisting of radiation with the Xenon arc lamp for 1 hour and 42 minutes and that for 18 minutes under raining condition. After the test, the test panels were visually compared with the reserve panels which had been kept in the laboratory and evaluated according to the following standard:
◯: no discoloration or fading or deterioration in gloss perceived;
X: notable discoloration or fading and deterioration in gloss.

Furthermore, discoloration and fading value Δe was measured with calorimeter, CR-200™ (Konica Minoruta Holdings, Inc.), using diffuse illumination, 0° viewing angle geometry.

TABLE 2

| | | | | | Accelerated | |
|---|---|---|---|---|---|---|
| | | | | | Weatherability(*3) | |
| | | Color | High | | | Discolor- |
| | | Appear- | light | Shade | Visual | ation on or |
| | | ance | value | chroma | obser- | fading |
| No. | | (*1) | (L*)(*2) | (C*)(*2) | vation | (Δe) |
| Example | 1 | ∘ | 115.0 | 15.0 | ∘ | 0.1 |
| | 2 | ∘ | 114.5 | 15.2 | ∘ | 0.1 |
| Comparable | 1 | Δ | 120.0 | 6.5 | ∘ | 0.2 |
| Example | 2 | ∘ | 129.1 | 20.3 | x | 1.0 |
| | 3 | x | 86.3 | 18.6 | ∘ | 0.2 |

### INDUSTRIAL APPLICABILITY

This invention is highly useful for coating various industrial articles, in particular, outer panels of car bodies.

1. Red-colored metallic paint formulation which comprises a resin component, aluminum flake pigment and red iron oxide pigment, characterized in that it contains, per 100 parts by weight of total solid content of the resin component, 1-30 parts by weight of the aluminum flake pigment and 0.1-10 parts by weight of the red iron oxide pigment, and that the red iron oxide pigment has an average primary particle size of at least 200 nm.

2. The paint formulation as set forth in claim 1, which contains 3-25 parts by weight of the aluminum flake pigment per 100 parts by weight of total solid content of the resin component.

3. The paint formulation as set forth in claim 1, in which the aluminum flake pigment is non-leafing type.

4. The paint formulation as set forth in claim 1, which contains 0.5-8 parts by weight of the red iron oxide pigment per 100 parts by weight of total solid content of the resin component.

5. The paint formulation as set forth in claim 1, in which the red iron oxide pigment has an average primary particle size of 210-800 nm.

6. The paint formulation as set forth in claim 1, in which the resin component comprises main resin and crosslinking agent.

7. A method for forming multi-layered coating film, which comprises applying onto a substrate a paint formulation as set forth in claim 1, and then applying onto the formed coating film a clear paint.

8. The method as set forth in claim 7, in which the formed coating film has a value L* under highlight of at least 90 and a chroma C* in the shade of at least 10.

9. Articles coated by the method as set forth in claim 7.
